(19) United States
(12) Patent Application Publication
(10) Pub. No.: US 2026/0019155 A1
(43) Pub. Date: Jan. 15, 2026

(54) OPTICAL TRANSMISSION NODE, WAVELENGTH CONVERTER, AND METHOD FOR DRIVING WAVELENGTH CONVERTER

(71) Applicant: Fujitsu Limited, Kawasaki-shi (JP)

(72) Inventors: Akio SUGAMA, Atsugi (JP); Takeshi HOSHIDA, Kawasaki (JP)

(73) Assignee: Fujitsu Limited, Kawasaki-shi (JP)

(21) Appl. No.: 19/338,601

(22) Filed: Sep. 24, 2025

Related U.S. Application Data
(63) Continuation of application No. PCT/JP2024/009281, filed on Mar. 11, 2024.

(30) Foreign Application Priority Data
Mar. 30, 2023 (JP) 2023-056764

(51) Int. Cl. H04B 10/2581; G02B 27/28; G02F 1/35; H04B 10/291; H04B 10/40; H04B 10/50

(52) U.S. Cl. CPC H04B 10/2581; G02B 27/283; G02F 1/3507; G02F 1/353; H04B 10/2916; H04B 10/40; H04B 10/506

(57) ABSTRACT

An optical transmission node includes a first wavelength converter configured to convert an optical signal in a first wavelength band into an optical signal in a second wavelength band, a second wavelength converter configured to reconvert the optical signal in the second wavelength band to the optical signal in the first wavelength band, a pump light source used in common for the first wavelength converter and the second wavelength converter, and a coupler configured to distribute light emitted from the pump light source to the first wavelength converter and the second wavelength converter.

### CROSS-REFERENCE TO RELATED APPLICATIONS

This application is a continuation application of International Application No. PCT/JP2024/009281 filed on Mar. 11, 2024 and designated the U.S., which is based upon and claims priority to Japanese Patent Application No. 2023-056764 filed on Mar. 30, 2023, the entire contents of which are incorporated herein by reference.

### FIELD

The embodiments discussed herein are related to optical transmission nodes, wavelength converters, and methods for driving wavelength converters.

### BACKGROUND

In order to increase transmission capacities of optical communication networks, it is effective to expand a communication band through multiband transmission, using an S band and an E band having a shorter wavelengths than a C band, a U band having a longer wavelength than an L band, or the like, in addition to the C band and the L band that are currently reduced to practice. Although transponders or transceivers compatible with the C band and the L band have been reduced to practice, it is technically difficult to prepare a transponder compatible with a new wavelength band being considered for deployment. It is efficient to use a currently used device for the C band or the L band as the transponder, and to perform a wavelength conversion to another band at an optical transmission node on the network.

There is a proposed configuration for reducing optical phase fluctuations, that is, optical phase noise, in a differential phase shift keying (DPSK) system (refer to Patent Document 1 below, for example). There is a known configuration in which optical phase noise of a modulated optical signal is canceled using local oscillator (LO) emission at an optical transceiver node with self-homodyne detection scheme (refer to Patent Document 2 below, for example).

### PRIOR ART DOCUMENTS

### Patent Documents

Patent Document 1: Japanese Laid-Open Patent Publication No. 2011-182198
Patent Document 2: U.S. Patent. No. 9, 654,219

### NON-PATENT DOCUMENT

Non-Patent Document 1: W. Shieh et al., Opt. Express, 16, 15718-15727b (2008)

In systems with high symbol rates and large wavelength dispersion, requirements for laser phase noise are stringent, and lasers with narrow spectral linewidth are required. The symbol rate of state-of-the-art transponders exceeds 100 Gbaud, and when a margin is taken into consideration, the linewidth of the laser is preferably 100 kHz or less. However, there are many technical hurdles to manufacture the laser with the spectral linewidth of 100 kHz or less, and the state-of-the-art transponders operate with an insufficient margin in the linewidth.

In a case where the wavelength conversion is performed in an optical transmission node, such as an optical add-drop multiplexer (OADM) or the like, phase noise included in a pump light source (or pump source) used for the wavelength conversion is added to an optical signal and deteriorates the signal. The added phase noise is equivalent to the use of a laser with a large linewidth in the transponder, and a signal distortion increases during the transmission at a high symbol rate. As a number of locations where the wavelength conversion is performed increases, accumulation of the phase noise occurs.

### SUMMARY

Accordingly, it is an object in one aspect of the embodiments to provide an optical transmission node, a wavelength converter, and a method for driving the wavelength converter, which can suppress an accumulation of phase noise induced by wavelength conversion.

According to one aspect of the embodiments, an optical transmission node includes a first wavelength converter configured to convert an optical signal in a first wavelength band into an optical signal in a second wavelength band; a second wavelength converter configured to reconvert the optical signal in the second wavelength band to the optical signal in the first wavelength band; a pump light source used in common for the first wavelength converter and the second wavelength converter; and a coupler configured to distribute light emitted from the pump light source to the first wavelength converter and the second wavelength converter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a technical problem that may occur when performing a wavelength conversion in an optical transmission node for multi-band transmission;

FIG. 2 is a diagram expressing the technical problem of FIG. 1 by mathematical expressions;

FIG. 3 is a schematic diagram illustrating the optical transmission node according to an embodiment;

FIG. 4 is a diagram illustrating a configuration example of a wavelength converter;

FIG. 5 is a diagram illustrating a relationship between a symbol rate and a required linewidth;

FIG. 6 is a diagram illustrating a relationship between a ratio (%) of differences of L_{A}+L_{B} and L_{C} with respect to a coherence length, and a SNR penalty increase;

FIG. 7 is a diagram illustrating a relationship between a number of traversed nodes, and the ratio (%) of the differences of L_{A}+L_{B} and L_{C} with respect to the coherence length, for different SNR penalty increases;

FIG. 8 is a diagram illustrating a relationship between the symbol rate, and a difference (m) between L_{A}+L_{B} and L_{C};

FIG. 9 is a diagram illustrating a configuration example of a wavelength converter for polarization diversity;

FIG. 10 is a schematic diagram of a four-degree optical transmission node; and

FIG. 11 is a diagram illustrating path lengths L_{A}, L_{B}, and L_{C} of wavelength converters used in FIG. 10.

### DESCRIPTION OF EMBODIMENTS

Preferred embodiments of the present disclosure will be described with reference to the accompanying drawings.

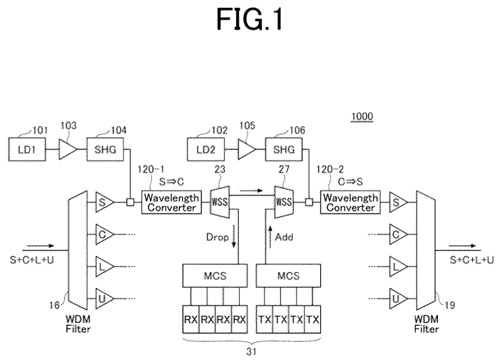

FIG. 1 illustrates a technical problem that may occur when performing a wavelength conversion in an optical transmission node 1000 for multi-band transmission. The optical transmission node 1000 is used in a multi-band wavelength division multiplexing (WDM) system that performs a wavelength division multiplexing (WDM) transmission of optical signals in a plurality of wavelength bands, and is an OADM node, for example. In this example, an S band (1460 nm 1530 nm), a C band (1530 nm to 1565 nm), an L band (1565 nm to 1625 nm), and a U band (1625 nm to 1675 nm) are used as the plurality of wavelength bands. Further, bands of a multi-band WDM system do not have to strictly follow these divisions, and for example, a region that spans two bands may be used. In the present disclosure, the bands as described herein also include such bands.

An optical signal input to the optical transmission node 1000 via a transmission line is separated into respective wavelength bands by a WDM filter 16. One or more transponders 31 are connected to the optical transmission node 1000 via a multi-cast switch (MCS). Each transponder 31 has a transmitter (TX) and a receiver (RX), and is also referred to as an optical transceiver. In the optical transmission node 1000, the signal transmitted from the transponder 31 is added and transmitted to a target path (or degree). The signal dropped in the optical transmission node 1000 is received by a destination transponder 31.

The transponder 31 is capable of processing signals in the C band and the band, but is not capable of processing signals in other wavelength bands. For this reason, the optical transmission node 1000 performs a wavelength conversion between the signal in the C band or the L band that can be processed by the transponder 31, and a signal in a wavelength band other than the C band and the L band. In the example illustrated in FIG. 1, the wavelength conversion is performed between the S band and the C band, but the wavelength conversion may be performed between the S band and the L band, between the C band and the U band, and between the L band and the U band. The signals of the C band, the L band, the S band, and the U band will hereinafter also be referred to as a C-band signal, an L-band signal, an S-band signal, and a U-band signal, respectively.

The S-band signal separated by the WDM filter 16 is converted into the C-band signal by the wavelength converter 120-1, and a portion of the C-band signal is dropped to the transponder 31 by a wavelength selective switch (WSS) 23, and the other portion of the C-band signal passes through the optical transmission node 1000 as it is or is distributed to another path (or degree). The C-band signal added by a WSS 27 in the optical transmission node 1000 is converted from the C band to the S band by a wavelength converter 120-2, and is multiplexed with the signal of the other wavelength band by a WDM filter 19 and output to the transmission line.

The wavelength converter 120-1 from the S band to the C band, and the wavelength converter 120-2 from the C band to the S band are configured to operate in reverse. Pump light generated from output light of a pump source 101 (denoted as “LD1”) is input to the wavelength converter 120-1 together with the S-band signal light. Pump light generated from the output light of the pump source 102 (denoted as “LD2”) is input to the wavelength converter 120-2 together with the C-band signal light. In this configuration, a pump source is provided for each wavelength converter.

In a case where a wavelength conversion is performed between the S band and the C band, pump light with a wavelength of approximately 764 nm is required. Because it is difficult to acquire a high-power LD in this wavelength band, the output light of the pump source 101 is amplified by an optical amplifier 103, and light with the wavelength of 764 nm is generated by a second harmonic generator (indicated as “SHG” in FIG. 1) 104 and used as the pump light for the wavelength converter 120-1. Similarly, at an output side to the transmission line, the output light of the pump source 102 is amplified by an optical amplifier 105, and the light with the wavelength of 764 nm is generated by a second harmonic generator (SHG) 106 and used as the pump light for the wavelength converter 120-2.

Each of the pump light sources 101 and 102 includes phase noise. The phase noise of the pump light incident on the wavelength converter 120-1 is added to the signal light, and the phase noise of the pump light incident on the wavelength converter 120-2 is added to reconverted light reconverted to the S band. Each transponder 31 operates at a high symbol rate, and there is insufficient margin in a light source (LD) used in the transponder 31. When the phase noise is added for each pump source, the added phase noise is equivalent to the use of a light source (LD) having a wide linewidth in the transponder 31, thereby deteriorating the signal.

In addition, there is a variation in the wavelength accuracy of the pump sources 101 and 102. When the wavelength accuracy variation is accumulated, the wavelength itself of the signal light may shift. In this case, the signal wavelength of the S band reconverted by the wavelength converter 120-2 may deviate from the signal wavelength of the S band incident on the optical transmission node 1000.

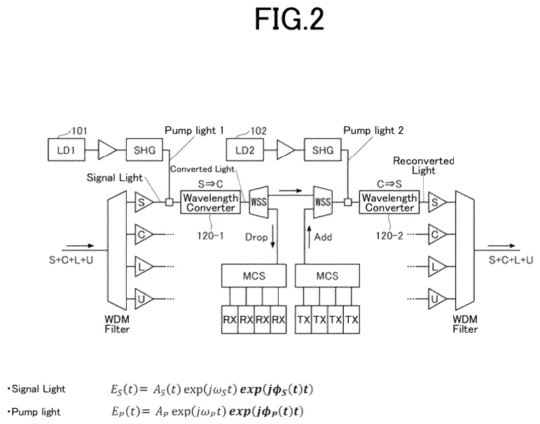

FIG. 2 is a diagram expressing the technical problem of FIG. 1 by mathematical expressions. Signal light E_{S}(t) and pump light E_{P}(t) incident on the wavelength converter 120-1, the converted light E_{I}(t) generated from the wavelength converter 120-1, and reconverted light E_{S′}(t) reconverted by the wavelength converter 120-2 can be expressed as follows.

$$\begin{matrix}{E}_{S} ( t ) = {A}_{S} ( t ) exp ( j {ω}_{S} t ) exp ( j {ϕ}_{S} ( t ) t ) \\ {E}_{P} ( t ) = {A}_{P} exp ( j {ω}_{P} t ) exp ( j ( {ϕ}_{P} ( t ) t ) \\ {E}_{I} ( t ) = {A}_{S} ( t ) exp ( j ( {ω}_{P 1} - {ω}_{S} ) t ) exp ( j ( {ϕ}_{P 1} ( t ) - {ϕ}_{S} ( t ) ) t ) \\ {E}_{S ′} ( t ) = {A}_{S} ( t ) exp ( j ( {ω}_{S} + {ω}_{P 2} - {ω}_{P 1} ) t ) exp ( j ( {ϕ}_{S} ( t ) + {ϕ}_{P 2} ( t ) - {ϕ}_{P 1} ( t ) ) t )\end{matrix}$$

The reconverted light E_{S′}(t) output from the wavelength converter 120-2 includes a difference (ωP2-ωP1) between an angular frequency ω_{P2} of pump light 1 and ω_{P2} of pump light 2, and a phase difference (ϕ_{P2}(t)−ϕ_{P1}(t)) between the pump light 1 and the pump light 2. The term “ω_{P2}−ω_{P1}” represents a frequency offset (that is, a wavelength variation) of the pump source, and the term “ϕ_{P2}(t)−ϕ_{P1}(t)” represents the phase noise. The frequency offset may be referred to as a frequency shift or a frequency variation.

The phase noise and the frequency offset increase as the number of pump sources used for the conversion between specific wavelength bands increases. For example, when the conversion between the S band and the C band is performed for each path of a plurality of paths and an individual pump source is used for each wavelength converter, the phase noise and the frequency offset are accumulated, and the signal deterioration inside the optical transmission node increases. Further, the phase noise is accumulated every time the signal passes through a plurality of optical transmission nodes, thereby also increasing the signal deterioration.

Configurations of embodiments of the present disclosure are conceived and implemented to solve the problem of phase noise accumulation. The configurations of the embodiments that suppress the accumulation of phase noise can also solve the problem of wavelength accuracy variation. Hereinafter, specific configurations and methods of suppressing the accumulation of phase noise according to the embodiments will be described with reference to the drawings. The embodiments described below are merely examples for embodying the technical concept of the present disclosure, and do not limit the scope of the present disclosure. The sizes, positional relationships, or the like of constituent elements (or components) illustrated in the drawings may be exaggerated to facilitate understanding of the present disclosure. The same constituent elements or functions are designated by the same names or reference numerals, and a redundant description thereof may be omitted.

### Optical Transmission Node of Embodiment

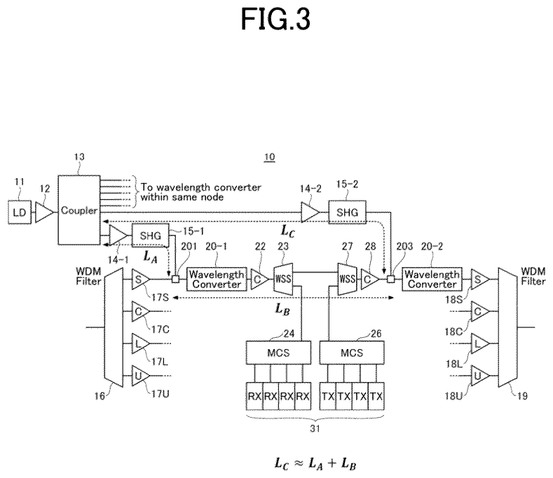

FIG. 3 is a schematic diagram of an optical transmission node 10 according to an embodiment. The optical transmission node 10 includes a wavelength converter 20-1 that converts an optical signal in a first wavelength band into an optical signal in a second wavelength band, a wavelength converter 20-2 that reconverts the optical signal in the second wavelength band into the optical signal in the first wavelength band, and a pump source 11 (denoted as “LD” in FIG. 3) that is used in common between the wavelength converters 20-1 and 20-2. The optical transmission node 10 also includes a coupler 13 that distributes the light output from the pump source 11 to the wavelength converter 20-1 and the wavelength converter 20-2.

The first wavelength band is used for optical transmission over the network, but this first wavelength band cannot be processed by the transponders 31 connected to the optical transmission node 10 via MCSs 24 and 26. The second wavelength band can be processed by the transponders 31. In the example illustrated in FIG. 3, the first wavelength band is the S band, and the second wavelength band is the C band. In the wavelength conversion between the C band and the U band or between the L band and the U band, the first wavelength band is the U band, and the second wavelength band is the C band or the L band. Add and drop configurations via WSSs 23 and 27 are as described with reference to FIG. 1. An optical amplifier 22 for the C band may be provided at a stage preceding the WSS 23, and an optical amplifier 28 for the C band may be provided at a stage subsequent to the WSS 27, as required.

An optical signal incident on the optical transmission node 10 via a transmission line is separated into a plurality of wavelength bands by a WDM filter 16. The signals of the respective wavelength bands separated by the WDM filter 16 are amplified by the preamplifiers 17S, 17C, 17L, and 17U for the respective wavelength bands. With regard to the S band, for example, the S-band signal light amplified by the preamplifier 17S is input to the wavelength converter 20-1 together with the pump light, and is converted into a C-band signal.

The pump light input to the wavelength converter 20-1 is generated using the light distributed by the coupler 13. The coupler 13 distributes the light output from the pump source 11 and amplified by the optical amplifier 12 to the wavelength converters 20-1 and 20-2. Although FIG. 3 illustrates a signal transmission to one path (or channel) for the sake of convenience to simplify the illustration, a signal wavelength-converted from the S band to the C band or a signal wavelength-converted from the C band to the S band may be sent to a plurality of paths (or degrees). In this case, the coupler 13 distributes the pump light to all the wavelength converters between the C-S bands provided with respect to the plurality of paths in the optical transmission node 10.

Because it is difficult to prepare a high-power laser light source suitable for the wavelength of the pump light used for the wavelength conversion between the S band and the C band, a laser light source with a wavelength of 1528 nm is used as the pump source 11, for example. The light for the wavelength converter 20-1 distributed by the coupler 13 is amplified by an optical amplifier 14-1, and becomes incident on a second harmonic generator 15-1, and pump light with a wavelength of 764 nm is generated by the second harmonic generator 15-1. The pump light from the second harmonic generator 15-1 is combined with the S-band signal light by an optical filter 201, and becomes incident on the wavelength converter 20-1. The second harmonic generator 15-1 uses a crystal having a nonlinear optical effect, and may use a ferroelectric crystal, such as a periodically poled lithium niobate (PPLN) or the like, for example.

The light for the wavelength converter 20-2 distributed by the coupler 13 is amplified by an optical amplifier 14-2, and becomes incident on a second harmonic generator 15-2, and pump light with a wavelength of 764 nm is generated by the second harmonic generator 15-2. The second harmonic generator 15-2 uses an optical crystal having a high nonlinear optical effect, such as PPLN or the like. The pump light output from the second harmonic generator 15-2 is combined with the C-band signal light passing through or added to the optical transmission node 10 by an optical filter 203, and becomes incident on the wavelength converter 20-2. Reconverted light that is wavelength-converted into the S band by the wavelength converter 20-2 is amplified by a post-amplifier 18S. The S-band signal light is combined with the light of other wavelength bands amplified by post-amplifiers 18C, 18L, and 18U by a WDM filter 19, and is output to the transmission line.

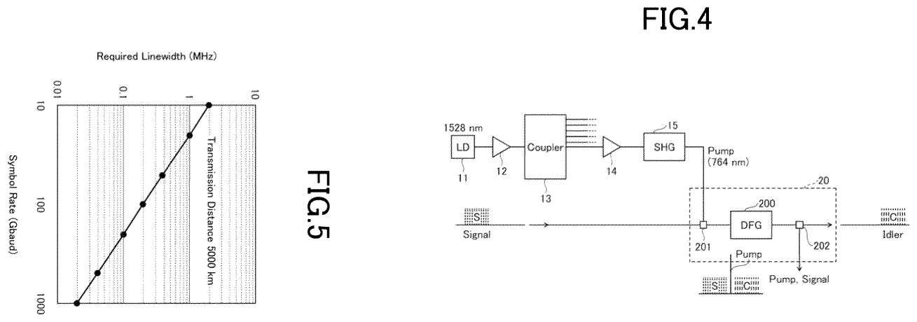

FIG. 4 illustrates a configuration example of a wavelength converter 20 used in the optical transmission node 10. The wavelength converter 20 includes the optical filter 201 for combining the pump light with the S-band signal light, a nonlinear optical medium 200, and an optical filter 202 for extracting the converted light of the C band from output light of the nonlinear optical medium 200.

S-band signal is a dense WDM (DWDM) signal in which signals of multiple wavelengths are densely arranged. The light distributed by the coupler 13 for the wavelength converter 20 is amplified to a power required for the wavelength conversion by an optical amplifier 14, and pump light with a desired wavelength is generated by a second harmonic generator 15. When the high-power pump light becomes incident on the nonlinear optical medium 200 together with the S-band signal light, idler light with a new wavelength band (in this case, the C band) is generated by a second order nonlinear effect, such as a difference frequency generation (DFG) or the like. The idler light, that is, the converted light, has a wavelength corresponding to an angular frequency difference or an energy difference between the signal light and the pump light.

A PPLN having a high conversion efficiency can be used for the nonlinear optical medium 200. Of the light output from the nonlinear optical medium 200, components of the pump light (Pump) and the signal light (Signal) are removed by the optical filter 202, and the idler light in the C band is extracted from the wavelength converter 20 as the converted light. Thus, the multiple DWDM signals included in the S band are collectively converted into the DWDM signals of the C band. In the wavelength converter 20-2 at the output side to the transmission path, the C-band signal light and the pump light generated from the distributed light become incident to the nonlinear optical medium 200, and the operation is opposite to the operation illustrated in FIG. 4. The multiple DWDM signals included in the C band are collectively reconverted into the DWDM signals of the S band, and the reconverted light is output from the wavelength converter 20-2.

Referring back to FIG. 3, a path length between the coupler 13 and the wavelength converter 20-1, more specifically, a fiber length from the coupler 13 to a combining point (the optical filter 201 in FIG. 4) of the S-band signal light and the pump light, is denoted by L_{A}. A path length between the coupler 13 and the wavelength converter 20-2, more specifically, a fiber length from the coupler 13 to a combining point of the C-band signal light and the pump light, is denoted by L_{C}. A path length between the wavelength converters 20-1 and 20-2, more specifically, a fiber length from a combining point of the S-band signal light and the pump light to a combining point of the C-band signal light and the pump light, is denoted by L_{B}.

A relationship among the path lengths L_{A}, L_{B}, and L_{A} is adjusted such that a phase of the phase noise generated in the converted light output from the wavelength converter 20-1 by a portion of the pump light from the pump source, and a phase of the phase noise generated in the reconverted light output from the wavelength converter 20-2 by another portion of the pump light cancel each other. Further, when a tolerable error of the path length inside the optical transmission node is denoted by ±Δ, an optical wiring (or optical routing) in the optical transmission node 10 is designed so that the following formula is satisfied.

$${L}_{C} = {L}_{A} + {L}_{B} \pm Δ$$

The fiber length of each path also includes an optical wiring length inside devices included in the path. For example, in a case where erbium-doped fiber amplifiers (EDFAs) or Raman amplifiers are used as the optical amplifiers 14-1, 14-2, 22, and 28, fibers having lengths of several tens of meters to several kilometers are housed inside the amplifiers, respectively. The lengths of these fibers are also included in the path length. An error within a certain range is tolerated in a length equivalence between L_{A}+L_{B} and L_{C}.

In the optical transmission node 10, by using the common pump source 11 for a plurality of wavelength converters used for the conversion between specific wavelength bands, an accumulation of the phase noise of the pump source can be suppressed, thereby enabling a signal distortion to be suppressed. In addition, a wavelength deviation caused by a wavelength accuracy variation between the pump sources can be suppressed. These features can be expressed by the following mathematical expressions.

$$\begin{matrix}{E}_{S} ( t ) = {A}_{S} ( t ) exp ( j {ω}_{S} t ) exp ( j {ϕ}_{S} ( t ) t ) \\ {E}_{P} ( t ) = {A}_{P} exp ( j {ω}_{P} t ) exp ( j ( {ϕ}_{P} ( t ) t ) \\ {E}_{I} ( t ) = {A}_{S} ( t ) exp ( j ( {ω}_{P 1} - {ω}_{S} ) t ) exp ( j ( {ϕ}_{P 1} ( t ) - {ϕ}_{S} ( t ) ) t ) \\ {E}_{S ′} ( t ) = {A}_{S} ( t ) exp ( j ( {ω}_{S} + {ω}_{P 2} - {ω}_{P 1} ) t ) exp ( j ( {ϕ}_{S} ( t ) + {ϕ}_{P 2} ( t ) - {ϕ}_{P 1} ( t ) ) t ) \\ = {A}_{S} ( t ) exp ( j {ω}_{S} t ) exp ( j {ϕ}_{S} ( t ) t )\end{matrix}$$

The wavelength conversion by DFG in the wavelength converter 20-1 can be represented as follows.

$$[ Converted light ] = [ Pump light ] - [ Signal light ]$$

Converted light E_{I}(t) output from the wavelength converter 20-1 includes, as differences between the pump light and the signal light, a component “ω_{P1}−ω_{S}” and a component “ϕ_{P1}(t)−ϕ_{S}(t)”. Reconverted light E_{S′}(t) output from the wavelength converter 20-2 is added with a component of the pump light generated from the distributed light, and includes a component “ω_{P2}−(ω_{P1}−ω_{S})” and a component “ϕ_{P2}(t)−ϕ_{P1}(t)−ϕ_{S}(t))”.

In a case where the same pump source 11 is used, ω_{P2}=ω_{P1}, and thus, “ω_{P2}−ω_{P1}” can be made zero. In addition, if the time t is the same, ϕ_{P2}(t)=ϕ_{P1}(t), and thus, “ϕ_{P2}(t)−ϕ_{P1}(t)” can be made zero or to a minimum, and a state substantially the same as the incident signal light E_{S}(t) is maintained. That is, the frequency offset and the phase noise are canceled by converting a certain wavelength band into another wavelength band and reconverting the other wavelength band into the original wavelength band. Particularly, by satisfying L_{C}=L_{A}+L_{B}±Δ, simultaneity is ensured and mixing of phase noise can be minimized. The tolerable error ±Δ of the path length in the optical transmission node 10 is an error in a range in which simultaneity is maintained to such an extent that influence of the phase noise can be suppressed.

### Range of Tolerable Error

FIG. 5 illustrates a relationship between a symbol rate and a required linewidth when a transmission distance is 5000 km. The optical transmission node 10 of the embodiment is applicable to a long-haul core network. The higher the symbol rate, the narrower the required linewidth of the laser light source used in the transponder 31. When the symbol rate of the transponders 31 is 100 Gbaud, the transponder 31 operates in a state where a certain margin is provided with the spectral linewidth of 100 kHz. When the wavelength conversion between specific wavelength bands is performed in the optical transmission node 10, the phase noise added to the signal light can be suppressed by distributing the output light of the same pump source 11 to the plurality of wavelength converters 20 so as to satisfy L_{C}=L_{A}+L_{B}±Δ. While each transponder 31 is operated within the range of the margin of the laser linewidth, the mixing of the phase noise induced by the wavelength conversion can be suppressed, and the signal distortion can be suppressed.

A relationship represented by the following formula (1) stands between a laser linewidth f_{3dB} expressed in frequency, and a coherence length L_{Coh}, where c denotes the speed of light.

$${L}_{C o h} = \frac{C}{{f}_{3 d B}} \qquad ( 1 )$$

The narrower the laser linewidth, the longer the coherence length. When a refractive index of an optical fiber is taken into consideration, the coherence length of the laser light in the optical fiber at the linewidth of 100 kHz is approximately 2000 m.

In the wavelength conversion by the difference frequency generation (DFG), a relationship among phase noise f_{Signal} of the signal light expressed in frequency, phase noise f_{Pump} of the pump source 11, and phase noise f_{Idler} of the converted light can be expressed by the following formula (2).

$${f}_{Idler} ≅ \sqrt{{f}_{Signal}^{2} + {f}_{Pump}^{2}} \qquad ( 2 )$$

In order to reduce the phase noise of the converted light and output converted light having a narrow spectral linewidth, it is necessary to reduce the phase noise of the signal light and the phase noise of the pump light. The signal light noise is determined by the laser linewidth of the transponder 31. In the configuration illustrated in FIG. 3, the phase noise f_{Pump} derived from the pump light added to the phase noise of the signal light is canceled or minimized, and thus, it is possible to output the converted light having a linewidth that is substantially the same as the linewidth of the signal light.

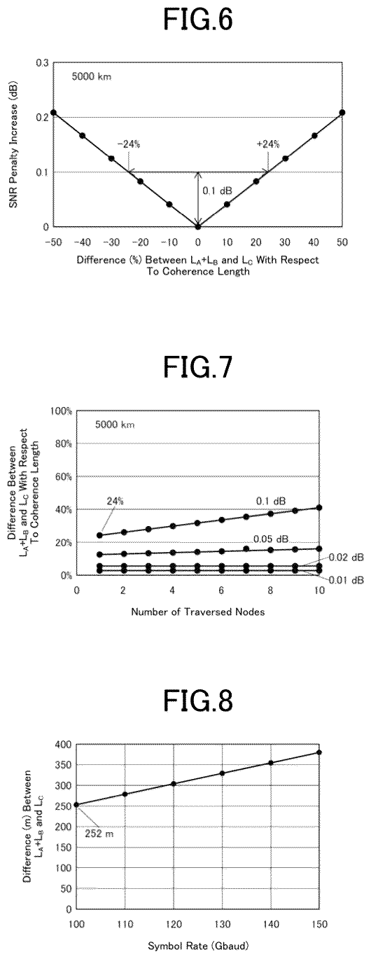

FIG. 6 illustrates a relationship between a ratio (%) of differences of L_{A}+L_{B} and L_{C} with respect to the coherence length L_{Coh}, and a SNR penalty increase ΔP (dB). According to Non-Patent Document 1 above, the SNR penalty increase ΔP (dB) can be approximated by the following relationship.

$$Δ P ( d B ) \approx 4.343 \times α ( 1 + {γ}_{0} )$$

In the relationship above, γ₀ denotes an effective SNR in the system including the phase noise, and α is approximated by the following relationship.

α≈πc(2f₀²)⁻¹DₜBf_{3dB}

In the relationship above, f₀ denotes a central wavelength of the laser of the transponder 31, Dₜ denotes an accumulated chromatic dispersion, B denotes a symbol rate, and f_{3dB} denotes a laser linewidth. In FIG. 6, the SNR penalty increase ΔP (dB) was calculated by setting the required linewidth of the transponder 31 and the linewidth of the pump source 11 to the same linewidth, setting the symbol rate B to 100 Gbaud, and setting the laser linewidth f_{3dB} to 100 kHz.

A path length error, that is, the difference between L_{A}+L_{B} and L_{C}, is determined as a percentage with respect to the coherence length L_{Coh}. The SNR penalty increases as an absolute value of the path error increases, centered on zero error, that is, L_{A}+L_{B}=L_{C}. For example, suppose that the tolerable SNR penalty increase per node is 0.1 dB. The SNR penalty increase of 1 dB is ±24% in terms of the path length error of the fiber length with respect to the coherence length. A path length error of approximately ¼ of the fiber length L_{C} is allowed between L_{A}+L_{B} and L_{C}. Of course, the tolerable SNR penalty increase per node may be set to less than 0.1 dB, and set to 0.05 dB, for example, in order to further reduce the tolerable path length error.

FIG. 7 is a diagram illustrating a relationship between a number of traversed nodes, and the ratio (%) of the differences of L_{A}+L_{B} and L_{C} with respect to the coherence length, for different SNR penalty increases. In a network, a signal passes through a plurality of nodes and undergoes wavelength conversion at each node. If the SNR penalty increase per node is 0.1 dB, the absolute value of the path length of the tolerable path length error at a first node is 24%. The tolerable path length error increases gradually as the number of nodes traversed by the signal light increases, because the phase noise is accumulated in the signal light by traversing the nodes, and the phase noise of the pump light becomes relatively small.

When the tolerable SNR penalty increase per node is 0.05 dB, a path length error of ±128 can be tolerated with respect to the coherence length. A slope of a change is small compared to a case where the SNR penalty increase per node is 0.1 dB. As the SNR penalty increase is decreased to 0.02 dB and 0.01 dB, the ratio of the difference between L_{A}+L_{B} and L_{C} with respect to the coherent length becomes substantially constant regardless of the number of nodes traversed by the signal light, according to the decrease in the tolerable path length error.

FIG. 8 is a diagram illustrating a relationship between the symbol rate, and a difference (m) between L_{A}+L_{B} and L_{C} when the SNR penalty increase per node is 0.1 dB. The difference between L_{A}+L_{B} and L_{C} is converted as an actual distance (physical fiber length), not as a ratio with respect to the coherence length. When the symbol rate is 100 Gbaud, the difference between L_{A}+L_{B} and L_{C} is 252 m. Even if a path length error of 250 m or less is present in the optical fibers used for the transmission paths L_{A}, L_{B}, and L_{C} of the optical transmission node 10, a symbol rate of 100 Gbaud or greater can be supported. The wavelength conversion is performed to mainly convert the signal to the C band and the L band, and thus, an EDFA can be used for the optical amplifier. Because an internal fiber length of the EDFA is several tens of meters, the fiber length error between actual amplifiers is within several tens of meters. The tolerable SNR penalty increase per node may be set to less than 0.1 dB, such as to 0.05 dB, for example.

### Modification of Wavelength Converter

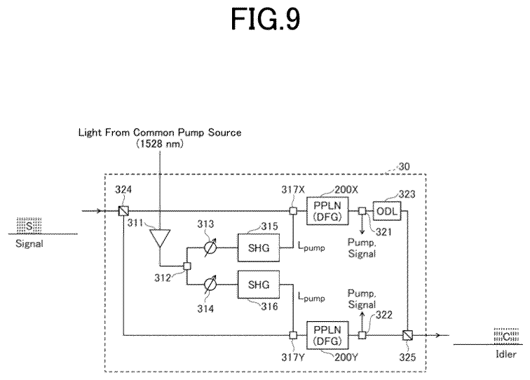

FIG. 9 illustrates a configuration example of a wavelength converter 30 for polarization diversity. The wavelength converter 30 includes a polarization beam splitter 324, a polarization beam combiner 325, a nonlinear optical medium 200X for X-polarization, and a nonlinear optical medium 200Y for Y-polarization.

Signal light S input to the wavelength converter 30 is split into two mutually orthogonal polarized lights by the polarization beam splitter 324. In this example, the mutually orthogonal polarized lights are referred to as an X-polarization and a Y-polarization. The wavelength converter 30 receives light output from the pump source 11 used in common by a plurality of wavelength converters and distributed by the coupler 13 (refer to FIG. 3). Assuming that the wavelength conversions between the S band and the C band are performed, the wavelength of the distributed light is set to 1528 nm.

The distributed light is amplified by an optical amplifier 311 and split by a beam splitter 312. Powers of the split lights are adjusted by variable optical attenuators (VOAs) 313 and 314, respectively, and resultant lights are input to second harmonic generators 315 and 316, respectively. Pump light (Lₚᵤₘₚ) generated by the second harmonic generator 315 is combined with the X-polarized light by a combiner 317X. Pump light (Lₚᵤₘₚ) generated by the second harmonic generator 316 is combined with the Y-polarized light by a combiner 317Y.

The X-polarized light and the pump light are incident on the nonlinear optical medium 200X for the X-polarized light, and C band X-polarized light is generated by difference frequency generation (DFG). The optical filter 321 removes unnecessary or unwanted signal light and pump light, and extracts the C band X-polarized light. The Y-polarized light and the pump light are incident on the nonlinear optical medium 200Y for the Y-polarized light, and C band Y-polarized light is generated by DFG. The optical filter 322 removes unnecessary or unwanted signal light and pump light, and extracts the C band Y-polarized light. The C band X-polarized light and the C band Y-polarized light are delay-adjusted by an optical delay line (ODL) 323, combined by a polarization beam combiner 325, and output from the wavelength converter 30.

A configuration that is the same as the configuration illustrated in FIG. 9 can be used when a C-band signal is converted into an S-band signal on the output side to the transmission path. In this case, two pump lights are generated from light output from the common pump source and distributed by the coupler 13, and are combined into the C band X-polarized light and the C band Y-polarized light, respectively. By using the same pump source and satisfying L_{C}=L_{A}+L_{B}±Δ between the wavelength converter of the S-C conversion and the wavelength converter of the C-S conversion, it is possible to suppress accumulation of the phase noise and suppress signal distortion.

### Extension to Four-Degree Optical Transmission Node

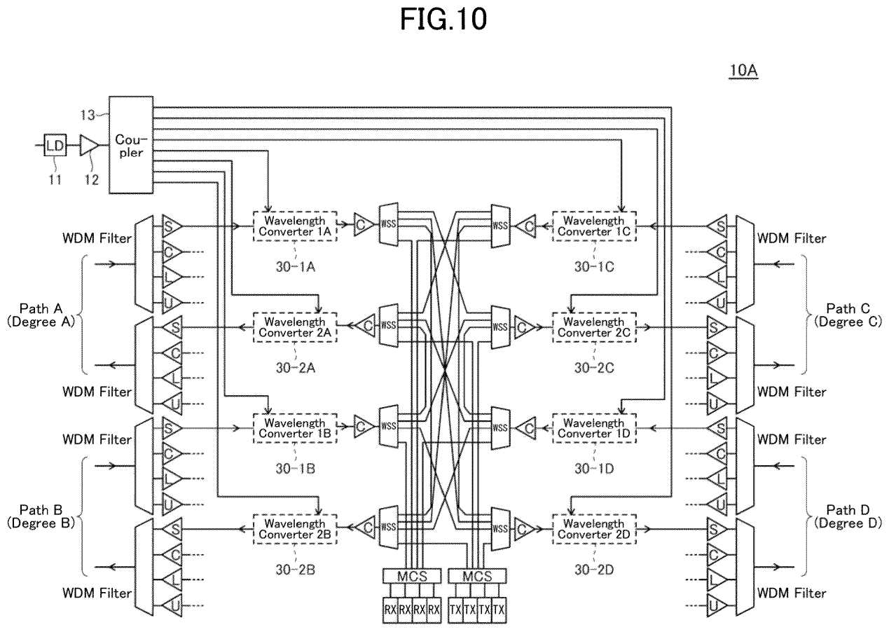

FIG. 10 is a schematic diagram of a four-degree optical transmission node 10A. Signal light incident on the optical transmission node 10A from each of the paths A, B, C, and D is output to a destination path. In FIG. 10, a connection relationship is illustrated by focusing on the wavelength conversions between the S band and the C band.

Among the wavelength converters 30, the wavelength converter disposed on the incident side from the transmission path is referred to as a wavelength converter 30-1, and the wavelength converter disposed on the output side to the transmission path is referred to as a wavelength converter 30-2. Further, in correspondence with the paths A, B, C, and D, the wavelength converter on the incident side from the path A is referred to as a wavelength converter 30-1A, and the wavelength converter on the output side to the path A is referred to as a wavelength converter 30-2A. The wavelength conversion from the S band to the C band performed by the wavelength converter 30-1A is referred to as “a wavelength-conversion 1A”, and the wavelength conversion from the C band to the S band performed by the wavelength converter 30-2A is referred to as “a wavelength-conversion 2A”. The same applies to the paths B, C, and D and the corresponding wavelength converters.

In the optical transmission node 10A, the pump source 11 is also used in common for the wavelength converters 30-1A, 30-2A, 30-1B, 30-2B, 30-1C, 30-2C, 30-1D, and 30-2D that perform wavelength conversions between the S band and the C band. Each of the wavelength converters 30-1A, 30-1B, 30-1C, and 30-1D has the polarization diversity configuration illustrated in FIG. 9, but is not limited thereto. The wavelength converters 30-2A, 20-2B, 30-2C, and 30-2D perform an operation opposite to operation illustrated in FIG. 9, split the C-band signal light by polarization, generate and combine the X-polarized light and the Y-polarized light of the S band according to the incident pump light, and output the S band converted light.

The pump light output from the pump source 11 is split by the coupler 13 and distributed to the wavelength converters 30-1A, 30-2A, 30-1B, 30-2B, 30-1C, 30-2C, 30-1D, and 30-2D. The pump light may be amplified by the optical amplifier 12 before being input to the coupler 13. A sum of the path length LA from the coupler 13 to the wavelength converter 30-1A and the path length Le from the wavelength converter 30-2C to, for example, the wavelength converter 30-2C, are the same as the path length Lc from the coupler 13 to the wavelength converter 30-2C, within the range of the tolerable error ±Δ(L_{C}=L_{A}+L_{B}±Δ).

For each of the plurality of combinations of the paths, L_{C}=L_{A}+L_{B}±Δ is satisfied. Due to this isometry, that is, simultaneity, the phase noise derived from the pump light is canceled by undergoing the wavelength conversion and reconversion, and the signal distortion is suppressed. Further, because the same pump source 11 is used, the problem of wavelength variation between pump sources will not occur.

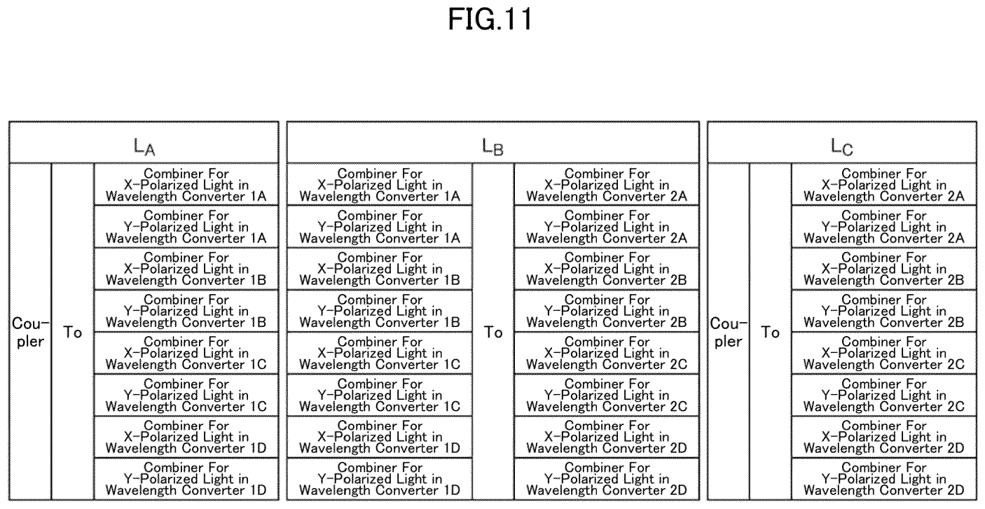

FIG. 11 illustrates the path lengths L_{A}+L_{B} and L_{C} of the wavelength converters 30-1A, 30-2A, 30-1B, 30-2B, 30-1C, 30-2C, 30-1D, and 30-2D used in FIG. 10. The path length from the coupler 13 to the first wavelength converter, more specifically, the fiber length from the coupler 13 to the combiner 317X for X-polarized light (refer to FIG. 9 and FIG. 10) of the first wavelength converter, is denoted by L_{A}. The fiber length from the combiner 317X for X-polarized light of the first wavelength converter to the combiner 317X for X-polarized light of the second wavelength converter is denoted by L_{B}. The fiber length from the coupler 13 to the combiner 317X for X-polarized light of the second wavelength converter is denoted by L_{C}.

Similarly, for the Y-polarization, the fiber length from the coupler 13 to the combiner 317Y for Y-polarized light (refer to FIG. 9 and FIG. 10) of the first wavelength converter is denoted by L_{A}. The fiber length from the combiner 317Y for Y-polarized light of the first wavelength converter to the combiner 317Y for Y-polarized light of the second wavelength converter is denoted by L_{B}. The fiber length from the coupler 13 to the combiner 317Y for Y-polarized light of the second wavelength converter is denoted by L_{C}.

In FIG. 11, all of the lengths in the column of the path length L_{A} are set to the same length within a range which satisfies L_{C}=L_{A}±L_{B}±Δ. All of the lengths in the column of the path length L_{B} are also set to the same length within the range which satisfies L_{C}=L_{A}+L_{B}±Δ. Similarly, all of lengths in the column of the path length L_{C} are also set to the same lengths within the range which satisfies L_{C}=L_{A}+L_{B}±Δ. When the fiber lengths of the X-polarization and the Y-polarization are set to the same length in each of the wavelength converters 30-1A, 30-2A, 30-1B, 30-2B, 30-1C, 30-2C, 30-1D, and 30-2D, the polarization does not need to be considered separately.

By using the distributed light from the same pump source 11 and ensuring the simultaneity or identicalness of propagation, it is possible to suppress the accumulation of the phase noise derived from the pump light.

Although the wavelength conversions performed in the optical transmission nodes 10 and 10A are described above based on specific configuration examples, the present disclosure is not limited to the configuration examples described above. The configuration in which the light emitted from a single pump light source is distributed to a plurality of wavelength converters can also be applied to wavelength conversions between the C band and the U band and wavelength conversions between the L band and the U band. A method for driving a wavelength converter in the optical transmission node 10 or 10A may include: arranging, in an optical transmission node, a first wavelength converter that converts an optical signal in a first wavelength band (for example, the S band) into an optical signal in a second wavelength band (for example, the C band), and a second wavelength converter that reconverts the optical signal in the second wavelength band into the optical signal in the first wavelength band; and distributing light emitted from a single pump light source to the first wavelength converter and the second wavelength converter, and independently driving the first wavelength converter and the second wavelength converter.

In a preferred form of driving the wavelength converter, the relationship of L_{A}+L_{B} and L_{C} is adjusted so that the phase noise included in the output light of the first wavelength converter and the phase noise included in the output light of the second wavelength converter cancel each other. Alternatively, the optical wiring is designed so that L_{C}=L_{A}+L_{B}±Δ is satisfied so that the accumulation of the phase noise derived from the pump light is suppressed. In this case, it possible to suppress signal distortion caused by the addition of phase noise during transmission at a high symbol rate.

As the wavelength conversion element, a highly nonlinear fiber (HNLF) or the like may be used instead of the PPLN. The wavelength conversion of the HNLF is not DGF but a nonlinear effect of four-wave mixing (FWM). The effect of suppressing the signal distortion is the same as above for the wavelength conversion by FWM, although there are differences, such as the wavelength conversion by FWM being expressed by formulas different from the formulas (1) and (2) described above, the SHG being unnecessary because of the different pump light wavelength, or the like. The connection and switching of the transponder 31 may be performed by using a wavelength multiplexing/demultiplexing element, such as a multiple-input multiple-output wavelength selective switch, an arrayed waveguide grating (AWG), or the like, in place of the MCS.

Various aspects of the subject matter described herein may be set out non-exhaustively in the following numbered clauses:

### Clause 1

An optical transmission node comprising:
a first wavelength converter configured to convert an optical signal in a first wavelength band into an optical signal in a second wavelength band;
a second wavelength converter configured to reconvert the optical signal in the second wavelength band to the optical signal in the first wavelength band;
a pump light source used in common for the first wavelength converter and the second wavelength converter; and
a coupler configured to distribute light emitted from the pump light source to the first wavelength converter and the second wavelength converter.

### Clause 2

The optical transmission node according to clause 1, wherein a relationship among a first path length between the coupler and the first wavelength converter, a second path length between the first wavelength converter and the second wavelength converter, and a third path length between the coupler and the second wavelength converter is adjusted so that a phase of phase noise generated in converted light output from the first wavelength converter due to pump light of the pump light source and a phase of phase noise generated in reconverted light output from the second wavelength converter due to the pump light cancel each other.

### Clause 3

The optical transmission node according to clause 1 or 2, wherein a formula L_{C}=L_{A}+L_{B}±Δ stands, where L_{A} denotes a first path length between the coupler and the first wavelength converter, L_{B} denotes a second path length between the first wavelength converter and the second wavelength converter, L_{C} denotes a third path length between the coupler and the second wavelength converter, and ±Δ denotes a tolerable error of a path length inside the optical transmission node.

### Clause 4

The optical transmission node according to clause 3, wherein the tolerable error falls within a range that makes a signal-to-noise ratio penalty increase 0.1 dB or less for traversing the optical transmission node.

### Clause 5

The optical transmission node according to clause 4, wherein the tolerable error falls within a range that makes a signal-to-noise ratio penalty increase 0.05 dB or less for traversing the optical transmission node.

### Clause 6

The optical transmission node according to any one of clauses 1 to 5, further comprising:
a first filter provided at a stage preceding the first wavelength converter and configured to combine first pump light generated from first distributed light distributed by the coupler with the optical signal in the first wavelength band; and
a second filter provided at a stage preceding the second wavelength converter and configured to combine second pump light generated from second distributed light distributed by the coupler with the optical signal in the second wavelength band.

### Clause 7

The optical transmission node according to clause 6, wherein the first pump light and the second pump light are second harmonics of the light emitted from the pump light source.

### Clause 8

The optical transmission node according to any one of clauses 1 to 7, further comprising:
a transponder configured to operate in the second wavelength band, and not in the first wavelength band.

### Clause 9

A wavelength converter comprising:
a first filter configured to combine pump light generated from a portion of light emitted from a pump light source used in common for wavelength conversions between a first wavelength band and a second wavelength band with signal light;
a nonlinear optical medium coupled to an output of the first filter and configured to generate converted light having a wavelength different from wavelengths of the pump light and the signal light, based on the pump light and the signal light; and
a second filter configured to extract the converted light from light emitted from the nonlinear optical medium.

### Clause 10

The wavelength converter according to clause 9, further comprising:
a polarization beam splitter configured to split the signal light into a first polarized light and a second polarized light; and
a polarization beam combiner configured to combine the first polarized light and the second polarized light, wherein:
the first filter includes a third filter configured to combine the pump light with the first polarized light, and a fourth filter configured to combine the pump light with the second polarized light,
the nonlinear optical medium includes a first nonlinear optical medium configured to generate first converted light of the first polarized light from the first polarized light, and a second nonlinear optical medium configured to generate second converted light of the second polarized light from the second polarized light, and
the polarization beam combiner combines the first converted light and the second converted light and outputs combined light.

### Clause 11

A method for driving a wavelength converter, comprising:
arranging, in an optical transmission node, a first wavelength converter that converts an optical signal in a first wavelength band into an optical signal in a second wavelength band, and a second wavelength converter that reconverts the optical signal in the second wavelength band into the optical signal in the first wavelength band; and
distributing light emitted from a single pump light source to the first wavelength converter and the second wavelength converter, and independently driving the first wavelength converter and the second wavelength converter.

### Clause 12

The method for driving the wavelength converter according to clause 11, further comprising:
providing a coupler that distributes the light emitted from the single pump light source; and
adjusting a relationship among a first path length between the coupler and the first wavelength converter, a second path length between the first wavelength converter and the second wavelength converter, and a third path length between the coupler and the second wavelength converter is adjusted so that a phase of phase noise generated in converted light output from the first wavelength converter due to pump light of the single pump light source and a phase of phase noise generated in reconverted light output from the second wavelength converter due to the pump light cancel each other.

### Clause 13

The method for driving the wavelength converter according to clause 11 or 12, further comprising:
providing a coupler that distributes the light emitted from the single pump light source; and
designing an optical wiring in the optical transmission node so that a formula L_{C}=L_{A}+L_{B}±Δ is satisfied, where L_{A} denotes a first path length between the coupler and the first wavelength converter, L_{B} denotes a second path length between the first wavelength converter and the second wavelength converter, L_{C} denotes a third path length between the coupler and the second wavelength converter, and ±Δ denotes a tolerable error of a path length inside the optical transmission node.

### Clause 14

The method for driving the wavelength converter according to clause 13, wherein the tolerable error is set to fall within a range that makes a signal-to-noise ratio penalty increase 0.1 dB or less for traversing the optical transmission node.

According to the embodiments of the present disclosure it is possible to provide an optical transmission node, a wavelength converter, and a method for driving the wavelength converter, which can suppress an accumulation of phase noise induced by wavelength conversion.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission node comprising:
a first wavelength converter configured to convert an optical signal in a first wavelength band into an optical signal in a second wavelength band;
a second wavelength converter configured to reconvert the optical signal in the second wavelength band to the optical signal in the first wavelength band;
a pump light source used in common for the first wavelength converter and the second wavelength converter; and
a coupler configured to distribute light emitted from the pump light source to the first wavelength converter and the second wavelength converter.

2. The optical transmission node as claimed in claim 1, wherein a relationship among a first path length between the coupler and the first wavelength converter, a second path length between the first wavelength converter and the second wavelength converter, and a third path length between the coupler and the second wavelength converter is adjusted so that a phase of phase noise generated in converted light output from the first wavelength converter due to pump light of the pump light source and a phase of phase noise generated in reconverted light output from the second wavelength converter due to the pump light cancel each other.

3. The optical transmission node as claimed in claim 1, wherein a formula L_{C}=L_{A}+L_{B}±Δ stands, where L_{A} denotes a first path length between the coupler and the first wavelength converter, L_{B} denotes a second path length between the first wavelength converter and the second wavelength converter, L_{C} denotes a third path length between the coupler and the second wavelength converter, and +Δ denotes a tolerable error of a path length inside the optical transmission node.

4. The optical transmission node as claimed in claim 3, wherein the tolerable error falls within a range that makes a signal-to-noise ratio penalty increase 0.1 dB or less for traversing the optical transmission node.

5. The optical transmission node as claimed in claim 4, wherein the tolerable error falls within a range that makes a signal-to-noise ratio penalty increase 0.05 dB or less for traversing the optical transmission node.

6. The optical transmission node as claimed in claim 1, further comprising:
a first filter provided at a stage preceding the first wavelength converter and configured to combine first pump light generated from first distributed light distributed by the coupler with the optical signal in the first wavelength band; and
a second filter provided at a stage preceding the second wavelength converter and configured to combine second pump light generated from second distributed light distributed by the coupler with the optical signal in the second wavelength band.

7. The optical transmission node as claimed in claim 6, wherein the first pump light and the second pump light are second harmonics of the light emitted from the pump light source.

8. The optical transmission node as claimed in claim 1, further comprising:
a transponder configured to operate in the second wavelength band, and not in the first wavelength band.

9. A wavelength converter comprising:
a first filter configured to combine pump light generated from a portion of light emitted from a pump light source used in common for wavelength conversions between a first wavelength band and a second wavelength band with signal light;
a nonlinear optical medium coupled to an output of the first filter and configured to generate converted light having a wavelength different from wavelengths of the pump light and the signal light, based on the pump light and the signal light; and
a second filter configured to extract the converted light from light emitted from the nonlinear optical medium.

10. The wavelength converter as claimed in claim 9, further comprising:
a polarization beam splitter configured to split the signal light into a first polarized light and a second polarized light; and
a polarization beam combiner configured to combine the first polarized light with the second polarized light, wherein:
the first filter includes a third filter configured to combine the pump light with the first polarized light, and a fourth filter configured to combine the pump light with the second polarized light,
the nonlinear optical medium includes a first nonlinear optical medium configured to generate first converted light of the first polarized light from the first polarized light, and a second nonlinear optical medium configured to generate second converted light of the second polarized light from the second polarized light, and
the polarization beam combiner combines the first converted light with the second converted light and outputs combined light.

11. A method for driving a wavelength converter, comprising:
arranging, in an optical transmission node, a first wavelength converter that converts an optical signal in a first wavelength band into an optical signal in a second wavelength band, and a second wavelength converter that reconverts the optical signal in the second wavelength band into the optical signal in the first wavelength band;
distributing light emitted from a single pump light source to the first wavelength converter and the second wavelength converter, and independently driving the first wavelength converter and the second wavelength converter.

12. The method for driving the wavelength converter as claimed in claim 11, further comprising:
providing a coupler that distributes the light emitted from the single pump light source; and
adjusting a relationship among a first path length between the coupler and the first wavelength converter, a second path length between the first wavelength converter and the second wavelength converter, and a third path length between the coupler and the second wavelength converter is adjusted so that a phase of phase noise generated in converted light output from the first wavelength converter due to pump light of the single pump light source and a phase of phase noise generated in reconverted light output from the second wavelength converter due to the pump light cancel each other.

13. The method for driving the wavelength converter as claimed in claim 11, further comprising:
providing a coupler that distributes the light emitted from the single pump light source; and
designing an optical wiring in the optical transmission node so that a formula L_{C}=L_{A}+L_{B}±Δ is satisfied, where L_{A} denotes a first path length between the coupler and the first wavelength converter, L_{B} denotes a second path length between the first wavelength converter and the second wavelength converter, L_{C} denotes a third path length between the coupler and the second wavelength converter, and ±Δ denotes a tolerable error of a path length inside the optical transmission node.

14. The method for driving the wavelength converter as claimed in claim 13, wherein the tolerable error is set to fall within a range that makes a signal-to-noise ratio penalty increase 0.1 dB or less for traversing the optical transmission node.
